(19) United States
(12) Patent Application Publication
(10) Pub. No.: US 2025/0378810 A1
(43) Pub. Date: Dec. 11, 2025

(54) Acoustic Panel With Replaceable Front

(71) Applicant: Adam Jones, San Diego, CA (US)

(72) Inventor: Adam Jones, San Diego, CA (US)

(21) Appl. No.: 19/218,117

(22) Filed: May 23, 2025

Related U.S. Application Data
(60) Provisional application No. 63/651,152, filed on May 23, 2024.

(51) Int. Cl. G10K 11/168

(52) U.S. Cl. CPC G10K 11/168

(57) ABSTRACT

An acoustic panel has a modular front cover that facilitates replacement by the end user and an acoustic insulator made from rigid fiberglass. The front cover is a silicone edge graphics panel made from an acoustically transparent cloth and removably insertable into a front frame attached to the rigid fiberglass board. An interior front cloth and a rear cloth, together with wooden exterior side panels, provide a protective barrier between the user and the rigid fiberglass board, even during removal and replacement of the front cover. Thus, an end user can replace a worn-out front cover with a new one, or simply replace the front cover whenever a new design is desired.

### RELATED APPLICATION

This application claims priority to U.S. Provisional Patent Application Ser. No. 63/651,152 for “Acoustic Panel with Replaceable Front,” filed May 23, 2024, and currently co-pending, the entirety of which is fully incorporated herein by reference.

### FIELD OF THE INVENTION

The present invention pertains generally to an aesthetic acoustic panel that has a removable front panel so that a user can customize its appearance.

### BACKGROUND OF THE INVENTION

Acoustic panels use sound absorbing materials that are used to reduce background noise, reverberation, echo in a space, and to improve the overall audio frequency response. Acoustic panels can be orientated either vertically, horizontally, or be freestanding, making them an attractive solution for use within a space that could benefit. Commonly, acoustic panels are used in recording studios or music halls to both insulate and improve the sound quality. However, their use in other settings, such as airport lounges, retail spaces, school settings, and even residential spaces, are starting to increase.

As acoustic panels become more and more common, having an artistic or panel with a specific color, is becoming an important design consideration. While these are an option for use, the main downside is that once a user buys a particular acoustic panel, they are stuck with the design. This results in an unnecessary cost of replacing the entire acoustic panel when a user desires a new design, requires a different sound frequency attenuation, or when the front of the acoustic panel becomes soiled, stained, or worn out.

### SUMMARY OF THE INVENTION

Disclosed is an acoustic panel with a modular front cover that is replaceable by an end user. The modular front cover allows users to easily replace existing designs with new ones. This makes acoustic panels easier to maintain and also greatly reduces the cost of replacing an existing design with a new one, since only the front cover needs to be replaced rather than the entire acoustic panel.

A preferred embodiment of the acoustic panel has a main acoustic insulation core made from a velocity-based sound absorber. Velocity-based sound absorbers are typically made out of a porous material, and as sound waves travel through the sound absorber, the energy from the sound wave is converted into thermal energy due to the friction that occurs between the porous material and the sound waves, which results in a reduction of the overall sound level. The velocity-based sound absorber used in a preferred embodiment of the acoustic panel of the present invention is rigid fiberglass, or, in an alternative preferred embodiment, stone wool.

Other components cover the main acoustic insulation panel and provide not only an aesthetic function, but also act as a barrier between the user and the fiberglass main acoustic insulation panel, thereby preventing irritation of the skin or lungs. The use of other insulators is also fully contemplated. For example, an alternative embodiment uses an acoustic panel made from recycled textiles, such as denim.

A rear cloth cover is affixed to the back of the acoustic insulation panel by a rear frame, and similarly, a front cloth cover is affixed to the front of the acoustic insulation panel by a front frame. The front cloth cover is an acoustically transparent material that may have a printed design and a connector or connectors to removably mount it onto the front frame. Preferred embodiments of the front frame are made from wood or metal. A preferred embodiment of the connection mechanism is a beading sewn into the edges of the front cloth cover that is received by a channel in the front frame, providing a nearly borderless graphic design to the front side of the acoustic panel in a modular, replaceable manner. In some alternative embodiments the rear cloth cover is also an acoustically transparent material that may have a printed design and a connector or connectors to removably mount it onto the rear frame.

Some alternative preferred embodiments can also use a second acoustic panel that is a pressure-based sound absorber. The second acoustic panel is positioned directly adjacent to the first acoustic panel, and in a preferred embodiment is constructed out of either plywood or medium density foam board. Pressure-based absorbers used in these embodiments are fine tuned for frequencies that are below 125 Hz, thereby supplementing the velocity-based sound absorbers that are typically less effective at those frequencies. Pressure-based sound absorbers work by interacting directly with the sound pressure waves and do so by converting the sound wave energy to mechanical energy in order to resonate. Some of the alternative preferred embodiments that have a second acoustic panel are configured so that the second acoustic panel can be easily replaced with a different panel in the event that the use of the room changes. In preferred alternative embodiments, only the pressure based acoustic panel is used and a velocity based acoustic panel is not used at all.

Since the front cloth cover is modular, it can be replaced as needed without requiring the user to replace the entire acoustic panel. The rear cloth cover can also be replaced as needed in those embodiments where a modular rear cloth cover is used. A user can therefore inexpensively change the design, or replace a soiled, stained, or worn-out front cloth cover.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded view of a preferred embodiment of an acoustic panel with a replaceable front;

FIG. 2 is a front view of the acoustic panel with a replaceable front, showing the various components;

FIG. 3 is a rear perspective view of a replaceable front of the acoustic panel with a replaceable front;

FIG. 4 is a cross-sectional view of the replaceable front taken at lines 4-4 from FIG. 3;

FIG. 5 illustrates the connection of the replaceable front to a front frame of the acoustic panel with a replaceable front;

FIG. 6 illustrates the connection of the replaceable front to an alternative embodiment of a front frame of the acoustic panel with a replaceable front;

FIG. 7 is a front perspective view of the acoustic panel with a replaceable front installed;

FIG. 8 is a front perspective view of the acoustic panel with a replaceable front in which the replaceable front is shown being removed from the front frame;

FIG. 9 is a front perspective view of the acoustic panel with a replaceable front in which an alternate replaceable front is shown being attached to the front frame;

FIG. 10 is a front perspective view of the acoustic panel with a replaceable front showing the alternate replaceable front attached;

FIG. 11 is an exploded view of a preferred embodiment of a dual acoustic panel device with a replaceable front;

FIG. 12 is an exploded view of an alternative embodiment of a dual acoustic panel device with a replaceable front;

FIG. 13 is a collection of charts illustrating noise reduction coefficients for various materials usable in an acoustic insulator;

FIG. 14 is a collection of charts illustrating noise reduction coefficients for exemplary multiple-acoustic-panel devices;

FIG. 15, are RT60 readings for a room before and after having the acoustic panel with a replaceable front installed;

FIG. 16 is a perspective view of a front frame with backlighting;

FIG. 17 is an exploded diagram of an alternative preferred embodiment of an acoustic panel with replaceable front and rear covers;

FIG. 18 is a diagram of an alternative embodiment of an acoustic panel with a replaceable wrap-around cover showing the panel in a flat configuration (A), installed on an acoustic panel base and wrapped around three sides (B), and the wrap-around cover in a rolled configuration for easy storage and transport (C);

FIGS. 19 and 20 depict an alternative embodiment of an acoustic panel with replaceable front showing attachment using multiple snaps or magnetic fasteners to secure the front panel to the frame;

FIG. 21 is a front view of an acoustic panel with a replaceable front that is designed to work with support stands;

FIG. 22 is a front view of an acoustic panel with a replaceable front that has upper eyelets allowing the panel to be hung from a ceiling;

FIG. 23 is an exploded view of an alternative embodiment of the present invention having a removable front cover and a removable rear cover; and

FIG. 24 is a front view of a removable rear cover that is installed on an alternative embodiment of the present invention.

### DETAILED DESCRIPTION

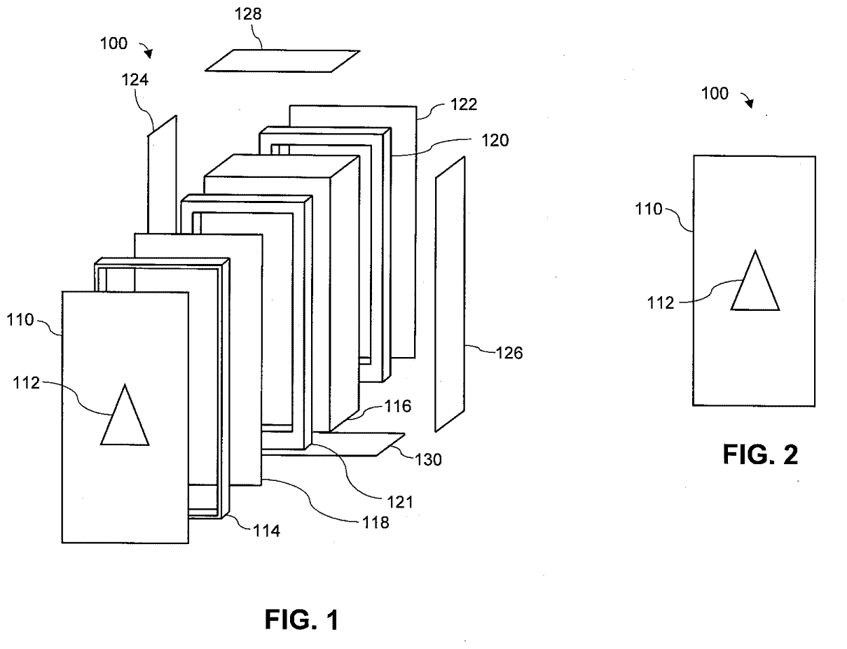

Referring initially to FIG. 1, an exploded view of a preferred embodiment of an acoustic panel 100 with a replaceable front is shown, illustrating the various components. Acoustic panel 100 has a front 110 removably attached to front frame 114. Preferred embodiments of front 110 cover or nearly cover the entirety of the front side of front frame 114, so that little or none of front frame 114 or other portions of acoustic panel 100 beyond front 110 are visible when installed.

In preferred embodiments, front 110 is made with an acoustically transparent cloth material. One such material used in some preferred embodiments is polyester. Front 110 is designed to be aesthetically pleasing, and has a solid color, design, or other illustration. Here, front 110 is shown with an exemplary design 112 for illustrative purposes. In a preferred embodiment, front frame 114 is made with channeled aluminum and a channel 138 (shown in FIG. 5) is formed between front frame 114 and left panel 124, right panel 126, top panel 128, and bottom panel 130 when acoustic panel 100 is fully assembled. Front 110 is a silicone edge graphics (SEG) print that mounts within channel 138 so that front 110 can be removably attached to front frame 114. Front frame 114 itself is mounted directly onto support frame 121. A user can then remove front 110 and replace it with another front 110 that has a different color, design, or illustration.

In an alternative preferred embodiment, front frame 114 is a prefabricated SEG frame that can be made out of plastic, aluminum, or any other suitable material currently known in the art. This embodiment of front frame 114 functions in substantially the same manner, allowing front 110 to be removably attached to front frame 114 such that a user can remove front 110 and replace it with another front 110 as desired. The use of wood for front frame 114 is also fully contemplated.

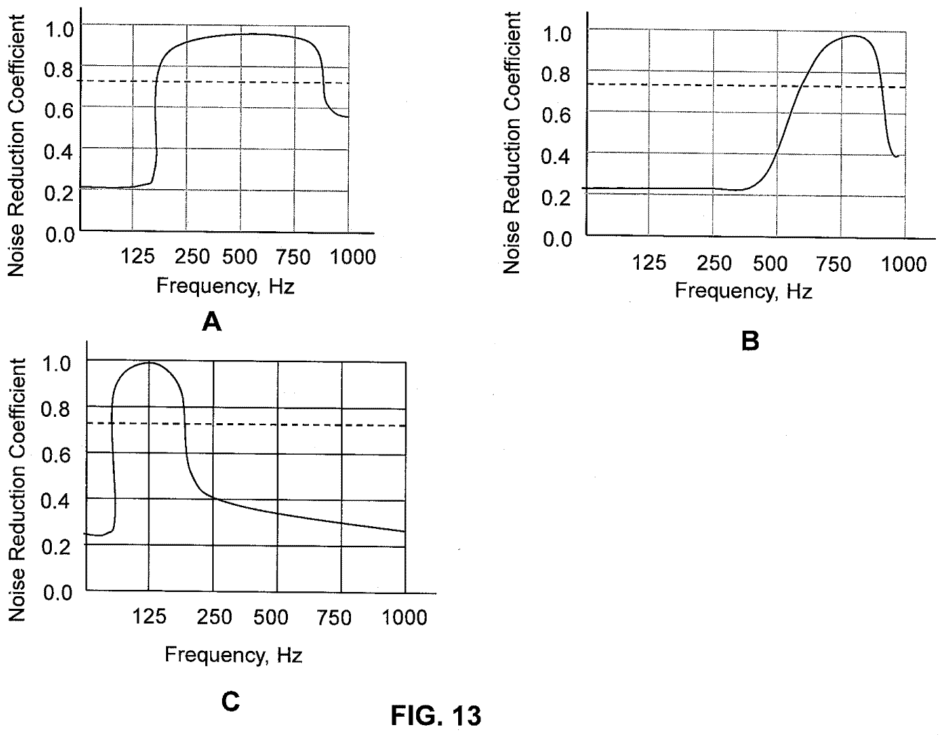

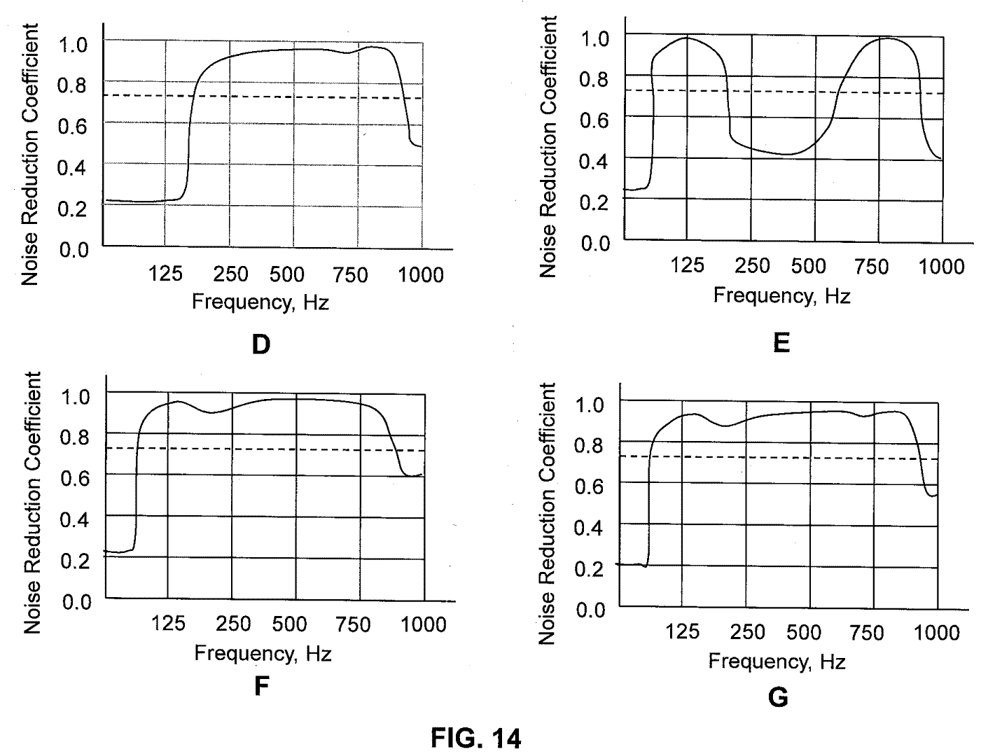

Alternate embodiments use other attachment mechanisms in place of the SEG attachment mechanism. An exemplary alternative embodiment uses magnet connectors to attach front 110 to front frame 114, and another exemplary alternative embodiment uses snap connectors, shown in FIGS. 13 and 14.

Acoustic insulator 116 is a board or panel made from a material with sound dampening properties. A preferred embodiment is made from rigid fiberglass, such as that sold under the mark Owens Corning Type 703. An alternative preferred embodiment is made from mineral wool insulation, such as that sold under the mark ROCKWOOL. An interior cloth 118 is located between support frame 121 and front frame 114 to act as a barrier for acoustic insulator 116 to prevent direct contact between the user and acoustic insulator 116. In some embodiments, multiple layers of the sound-dampening material are used; moreover, these layers vary in thickness in some embodiments.

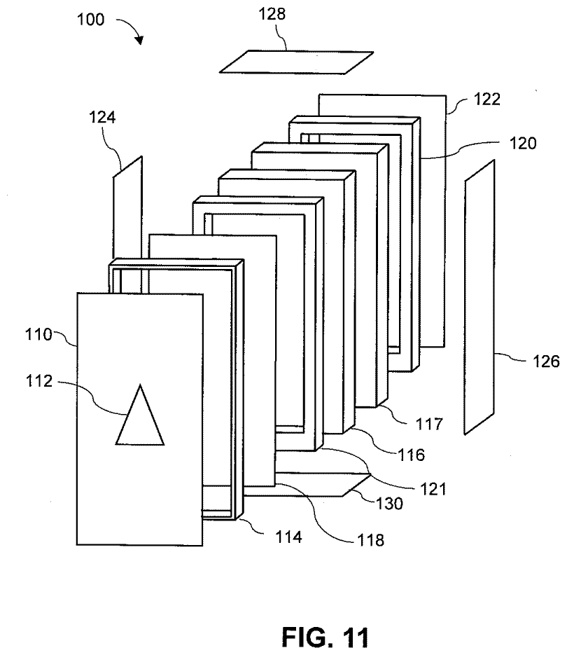

An alternative embodiment of acoustic insulator 116 is made from recycled textiles. The use of other insulating materials is also fully contemplated. It is also fully envisioned that acoustic insulator 117 (shown at least in FIG. 11) can be used in lieu of acoustic insulator 116 when only a specific frequency range needs to be absorbed by acoustic panel 100.

On the rear side of insulator 116 is rear frame 120, which is made of wood or medium-density fiberboard (MDF) in preferred embodiments. A rear cloth 122 is attached to the back of rear frame 120 to act as a barrier preventing direct contact between the user and acoustic insulator 116.

Exterior side panels, including left panel 124, right panel 126, top panel 128, and bottom panel 130 cover the remaining sides of acoustic insulator 116 and complete the external covering of acoustic panel 100. Preferred embodiments of these exterior side panels are made of wood, hardboard, MDF, or other suitable materials.

In an alternative embodiment, front frame 114 and rear frame 120 are removably attached to exterior side panels 124, 126, 128, and 130 with fasteners (not illustrated in this Figure), allowing them to be replaced by the end user as needed. As a result, acoustic panel 100 is modular and less expensive components can be replaced without requiring a new acoustic panel.

Referring now to FIG. 2, a front view of acoustic panel 100 is shown fully assembled. From the front side, front 110 is visible with its design 112. Little or none of front frame 114 (shown in FIG. 1) is visible, allowing several acoustic panels 100 to be arranged on a wall or ceiling with a pleasant aesthetic effect. Acoustic panel 100 can also be placed anywhere on the floor, desk, or any other mountable surface to provide the desired acoustic dampening and aesthetic effects. The suitability of different locations that acoustic panel 100 can be located means that any given layout of acoustic panel 100 can be fully customized to meet the sound needs of a given space.

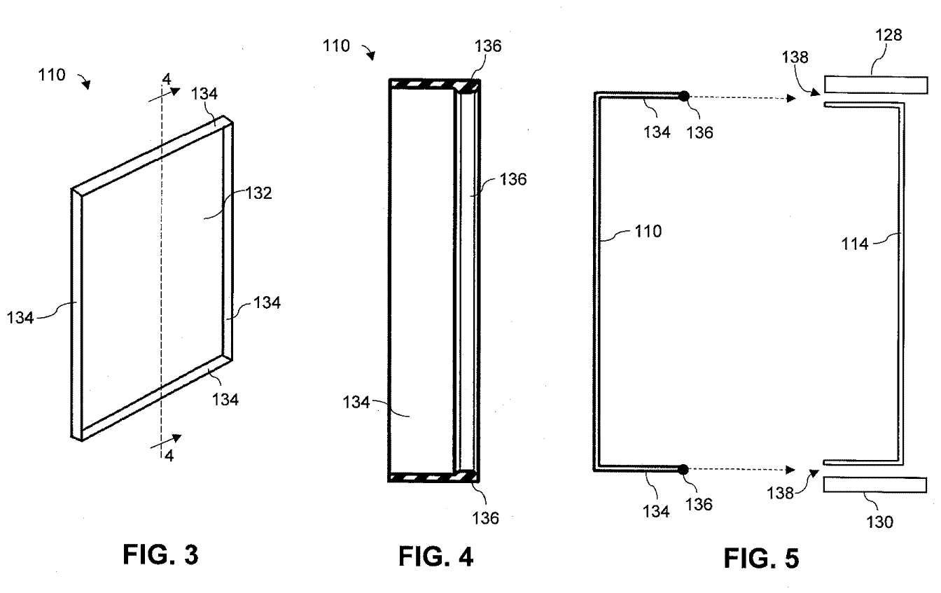

Referring now to FIG. 3, a rear perspective view of a preferred embodiment of front 110 is shown. Front 110 is an SEG print with edges 134 into which a small silicone strip or beading 136 (shown in FIG. 4) is sewn or otherwise attached. In some embodiments, the silicone strip or beading 136 is attached via an adhesive rather than stitched onto the fabric of front 110. Edges 134 are at a ninety (90) degree angle from the panel 132 of front 110 for insertion into front frame 114 (shown in FIGS. 1 and 5). As a consequence, design 112 (shown in FIG. 1) appears as a borderless graphic.

Referring now to FIG. 4, a cross-sectional view of front 110 is shown taken along lines 4-4 of FIG. 3. This view illustrates the portions of beading 136 along the left, top, and bottom edges 134 of front 110. This beading 136 continues along the remainder of the top, bottom, and right edges 134 to provide a secure fit into front frame 114.

Referring now to FIG. 5, a diagram showing how front 110 is inserted into a preferred embodiment of front frame 114 is provided. Front frame 114 is made out of channeled aluminum and channel 138 is formed by the space in between left panel 124, right panel 126, top panel 128, and bottom panel 130. Channel 138 is a consistent dimension throughout acoustic panel 100 when the present invention is fully assembled and showing only top panel 128 and bottom panel 130 in this section view was not intended to be limiting. Front 110 is installed by ensuring edges 134 are placed within channel 138, with beading 136 securing front 110 in place while installed. Beading 136 provides enough frictional force to hold front 110 in place while front 110 is installed, but it does not provide so much friction that it is difficult to install or remove front 110.

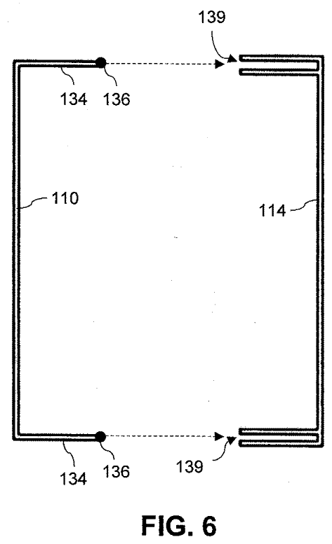

Referring now to FIG. 6, a diagram showing how front 110 is inserted into an alternative embodiment of front frame 114 is provided. Front frame 114 in this alternative embodiment is a prefabricated SEG frame and has channels 139 into which edges 134 are placed, with beading 136 securing front 110 in place in front frame 114 until removed by the user. As stated previously, using a SEG print and SEG frame are just one way of removably attaching front 110 to front frame 114. However, embodiments using other connectors, such as magnets or snaps, are fully contemplated.

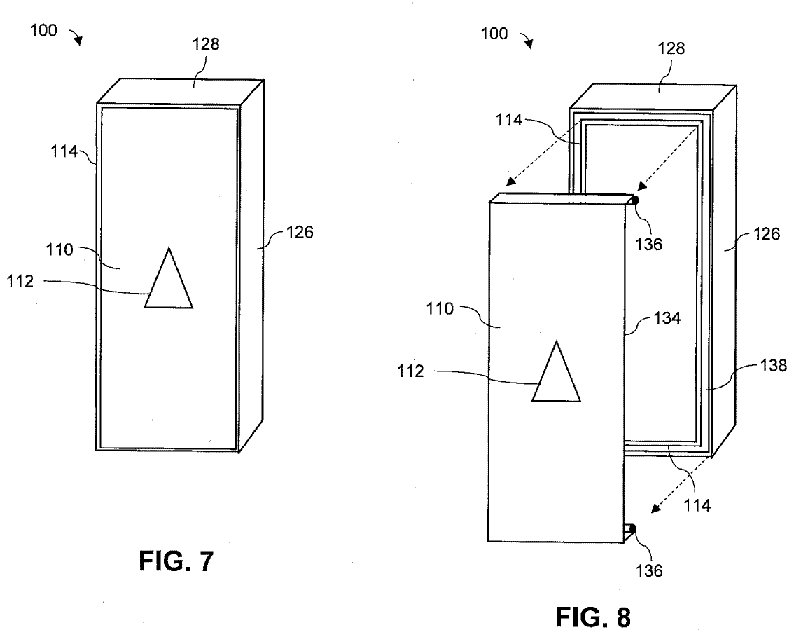

Referring now to FIG. 7, a front perspective view of a fully assembled acoustic panel 100 is illustrated. The front side of front frame 114 is minimally visible, if visible at all, when front 110 is in place. As a result, several acoustic panels 100 can be arranged side by side horizontally, vertically, both, or placed freestanding throughout a space, to provide a pleasing visual effect. This effect can be enhanced by having correlating designs 112 between panels 100, for example, a repeating pattern or a single large composite image extended across multiple panels 100. In a preferred embodiment, left panel 124 (shown in FIG. 1), right panel 126, top panel 128, and bottom panel 130 (shown in FIG. 1) cover the sides of front frame 114, as well as the sides of acoustic insulator 116 (shown in FIG. 1) and rear frame 120 (shown in FIG. 1). As a result, acoustic panel 100 appears as a single, simple panel to the end user both before and after installation.

Referring now to FIG. 8, removal of front 110 is illustrated. Front 110 is pulled away from front frame 114, resulting in the removal of front 110. More particularly edges 134 with beading 136 are released from the channel 138 of front frame 114. Removal is generally performed by an end user in order to replace front 110 with a different front 110.

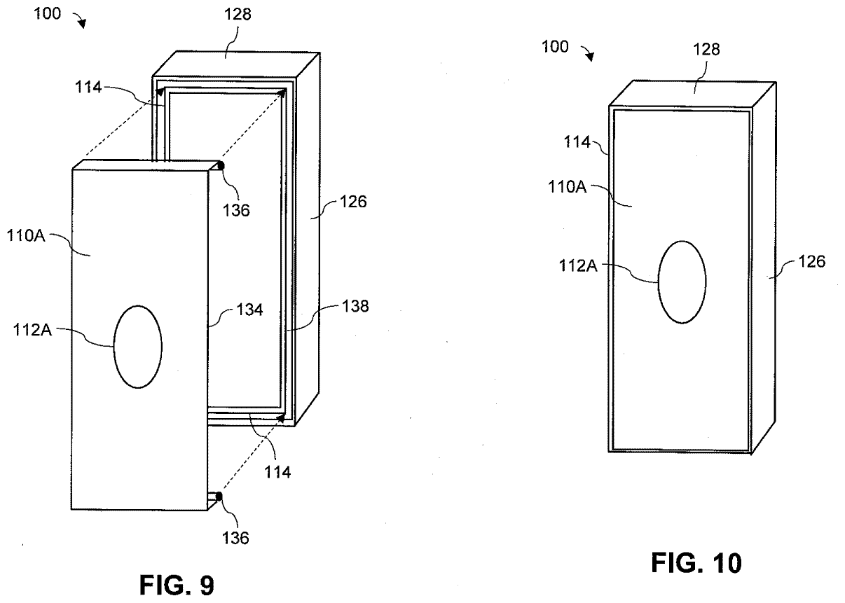

Referring now to FIG. 9, front 110 has been removed from front frame 114 and acoustic panel 100 generally, and the user is installing an alternate front 110A with a new design 112A. Similar to the installation of front 110, front 110A is aligned so that edges 134 and beading 136 are inserted into the channel 138 of front frame 114. Front 110A is then pressed into place.

Referring now to FIG. 10, a front perspective view of acoustic panel 100 is illustrated after installation of the new front 110A. Design 112 has now been replaced with design 112A.

Referring now to FIG. 11, an alternative preferred embodiment of acoustic panel 100 is illustrated. This embodiment is similar to the above-discussed embodiment of acoustic panel 100 (see FIG. 1), with front 110 with design 112, front frame 114, acoustic insulator 116, interior cloth 118, rear frame 120, rear cloth 122, left panel 124, right panel 126, top panel 128, and bottom panel 130. However, this embodiment of acoustic panel 100 also has a secondary acoustic insulator 117 alongside acoustic insulator 116 between interior cloth 118 and rear cloth 122. This allows for the use of both a velocity-based absorber and a pressure-based absorber. Acoustic insulator 117 can be made out of any known material for pressure-based insulators, including, but not limited to sheets of wood, pressed wood fibers, plastic, metal, rubber, paper, and foam. The final material selection for acoustic insulator 117 will be dependent on the specific needs of a space.

Although two acoustic insulators 116 and 117 are illustrated in FIG. 10 as a clear example of a preferred embodiment with multiple insulators, embodiments having three or more acoustic insulators are also fully contemplated herein. It will be apparent to one of ordinary skill in the art, by reviewing FIGS. 1 and 10, how additional acoustic insulators can be added to the apparatus. It is also fully envisioned that acoustic insulators 116 and 117 can be easily replaced with another acoustic insulator in order to fine tune acoustic panel 100 to a specific application. This provides added flexibility to acoustic panel 100 because instead of replacing the entire unit when different acoustics are required, a simple substitution of acoustic panels 116 and/or 117 needs to take place.

The use of an additional support frame 121, wooden in a preferred embodiment, behind front frame 114 is illustrated. Support frame 121 provides firmer support for a front frame 114, particularly when a prefabricated SEG frame is used for front frame 114. Embodiments without support frame 121 are fully contemplated, and embodiments otherwise similar to FIG. 1 that incorporate support frame 121 are also fully contemplated.

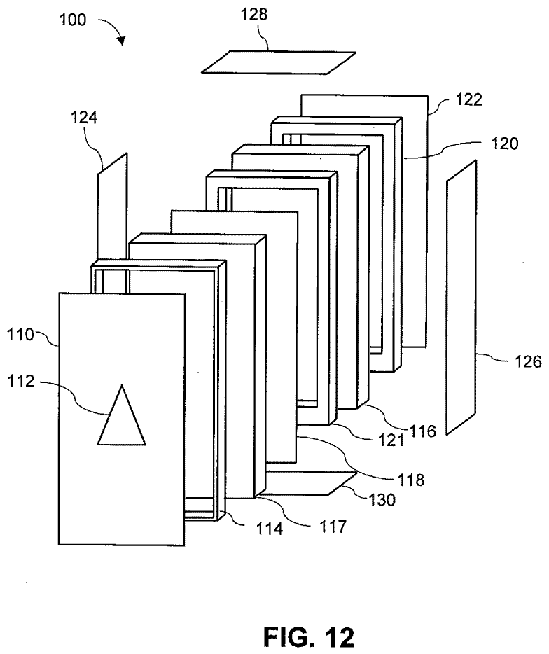

Referring now to FIG. 12, an exploded view of an alternative embodiment of acoustic panel 100 is shown. Acoustic panel 117 is fully modular in this alternative embodiment and is temporarily installed in-between front frame 114 and interior cloth 118. Acoustic panel 117 is modular due to the properties of pressure-based sound absorbers. In a nonlimiting example, a first type of acoustic panel 117 may be needed to absorb a first frequency range, but then the room use may temporarily change to where it is preferred to absorb a second frequency range. A user simply needs to exchange acoustic panel 117 with another panel that is fine tuned to absorb sound within the second frequency range instead of replacing the entire acoustic panel 100.

Acoustic panel 117 can either be screwed onto support frame 121, or be fastened by any other mechanisms such as magnetic fasteners, snap fasteners, or any other type currently known in the art. Front frame 114 is then mounted to acoustic panel 117 in a similar fashion. More specifically, front frame 114 may be fastened to acoustic panel 117 either through screws, magnetic fasteners, snap fasteners, or any other means known in the art. It is also fully contemplated that acoustic panel 117 can still be modular when located directly behind acoustic panel 116.

Referring now to FIG. 13, noise reduction coefficients by frequency are shown for acoustic panels with different sound absorbers. Chart A and Chart B show noise reduction for different velocity-based sound absorbers, effective for sound from about 200 Hz to about 800 Hz in Chart A, and from about 500 Hz to nearly 1000 Hz in Chart B. Chart C shows the sound absorption for a pressure-based sound absorber tuned to dampen sound at around 125 Hz. A pressure-based absorber as used in the acoustic panels described herein can be tuned to a desired frequency at or below 125 Hz, and, as seen in FIG. 13, tend to have a fairly narrow range of effective absorption around the tuned frequency.

Referring now to FIG. 14, noise reduction coefficients by frequency are shown for acoustic panels with more than one sound absorber each. For example, Chart D shows the noise reduction when the velocity-based sound absorbers of Charts A and B (shown in FIG. 13) are used together. Chart E shows the noise reduction when the velocity-based sound absorber of Chart B (shown in FIG. 13) is used together with the pressure-based sound absorber in Chart C (also shown in FIG. 13). Chart F shows the noise reduction when the velocity-based sound absorber of Chart A (shown in FIG. 13) is used with the pressure-based sound absorber of Chart C (shown in FIG. 13). Chart G shows the noise reduction when the sound absorbers of Charts A, B, and C (shown in FIG. 13) are all used together.

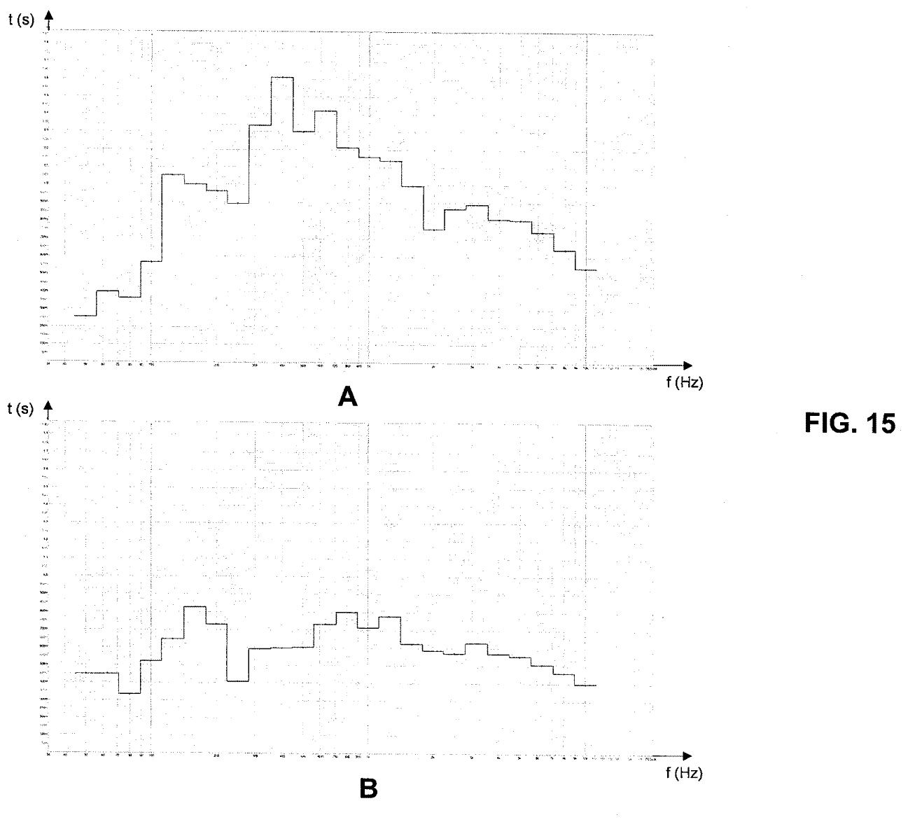

Referring now to FIG. 15, two different RT60 readings are shown. These different readings show the improved rates of sound decay over time within a space that has a given number of acoustic panels 100 installed. In this instance, multiple different acoustic panels 100 were placed in various locations in a conference room. The placement of the acoustic panels 100 resulted in improved rates of sound decay over time, meaning that the decibel rating for sounds produced within the conference room reduced at a much faster rate; resulting in a much better sound quality. Installing acoustic panels 100 within a conference room was not intended to be limiting as acoustic panels 100 can be installed in any given space and custom tailored to absorb a wide variety of different sounds that may be produced.

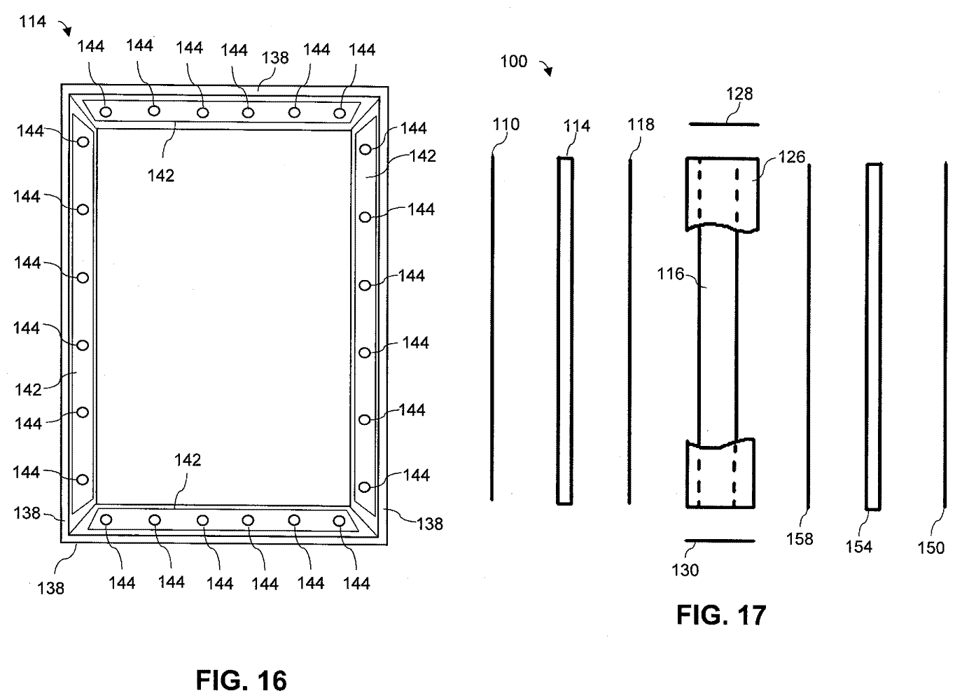

Referring now to FIG. 16, an alternative embodiment of front frame 114 with a channel 138 is shown, with strips 142 of light-emitting diode (LED) lights 144 mounted along the top, bottom, left, and right sides of front frame 114. LED lights 144 provide backlighting to front 110 (shown in FIG. 1). It will be apparent to one of ordinary skill in the art that LED lights 144 may be mounted in other locations, such as the top and bottom of front frame 114, all sides of front frame 114, across or behind front frame 114, or elsewhere, and that types of lights other than LED lights may be used. Embodiments with such alternate forms of backlight are fully contemplated herein.

Referring now to FIG. 17, in some preferred embodiments, panels on both sides of acoustic panel 100 are replaceable. An exemplary embodiment is illustrated and is structurally similar to previously-discussed embodiments, except that in place of rear frame 120 and rear cloth 122 (shown in FIG. 1) are back 150, back frame 154, and rear interior cloth 158. Back 150, back frame 154, and rear interior cloth 158 are structurally similar to front 110, front frame 114, and interior cloth 118, respectively. Thus, a user is able to replace both back 150 and front 110 as needed or desired, with rear interior cloth 158 protecting the user from direct contact with insulator 116 in the same manner as interior cloth 118 on the opposite side of insulator 116.

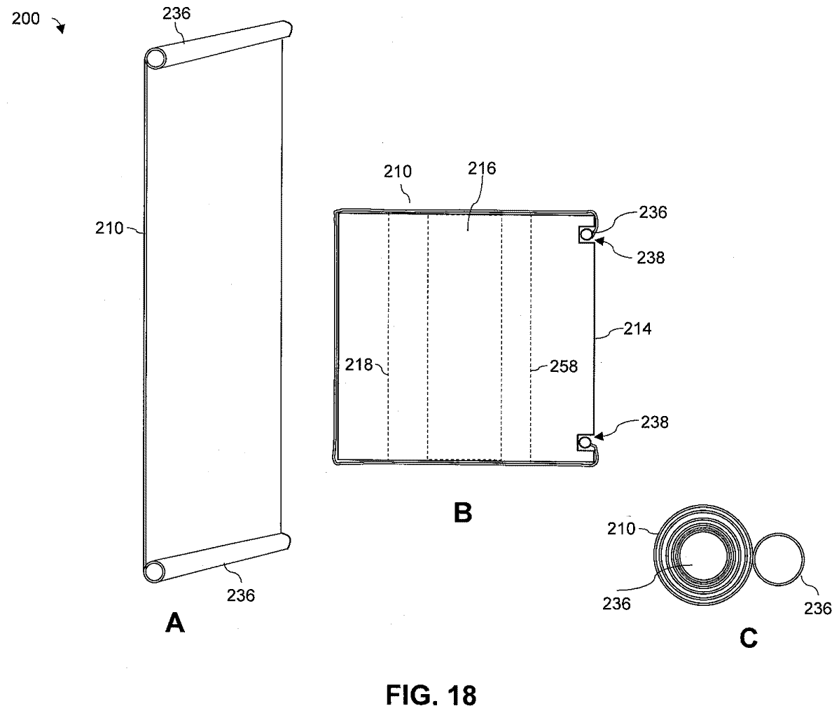

Referring now to FIG. 18, an alternative embodiment of an acoustic panel 200 with a replaceable front 210 is illustrated. As in other embodiments, front 210 removably attaches to frame 214 so that the user is able to replace it as desired. Insulator 216 is a panel made from a material with acoustic dampening properties, and is structurally similar to an insulator of the above-described embodiments. The use of any or a combination of the various types of insulators described above is fully contemplated. Front internal cloth 218 and rear internal cloth 258 protect the user from direct contact with insulator 216.

Front 210 attaches to frame 214 by the insertion of silicone strip or beading 236 into channels 238 of frame 214, in the same manner discussed above in connection with SEG frames. However, the use of other connectors as described above, whether in place of beading 236 and channels 238 or together with beading 236 and channels 238, is fully contemplated.

From FIG. 18, it can be appreciated that the alternative embodiment of an acoustic panel with a replaceable wrap-around cover 200 includes a fastener on only two sides, and can be installed on an acoustic panel base 214 and wrapped around three sides and fastened by inserting beads 236 into channels 238, as shown in view B. Important benefits of this embodiment of the acoustic panel with a replaceable wrap-around cover 200 includes the ability of the panel 210 to be stacked flat, or rolled into a rolled configuration for easy storage and transport, as illustrated in view C.

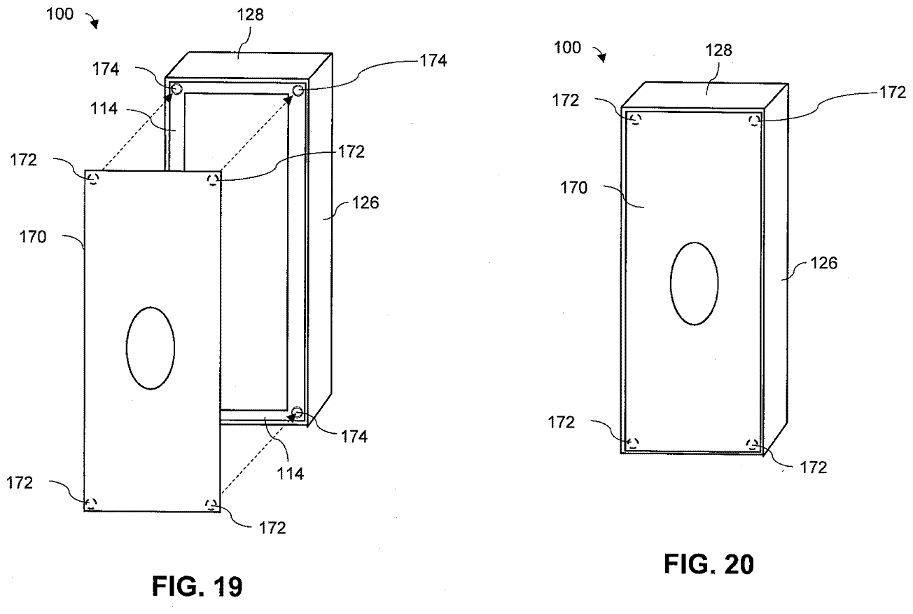

Referring now to FIGS. 19 and 20, an alternative embodiment of an acoustic panel with a replaceable front is shown with panel 170 having multiple two-part fasteners 172 and 174 which cooperate to removably attach panel 170 to front frame 114. As shown in FIG. 19, fasteners 172 and 174 are aligned and panel 170 is positioned such that the fasteners secure the panel 170 to the frame as shown in FIG. 20. In order to remove panel 170 from front frame 114, panel 170 is simply pulled away from front frame 114 to disconnect fasteners 172 and 174. It is to be appreciated that two-part fasteners 172 and 174 can be selected from a variety of well-known fasteners, such as a magnetic element 172 and a corresponding magnetic element 174, a two-part snap having a male snap 172 and a female snap 174, or a hook-and-loop fastener having a hook portion 172 and a loop portion 174. It is to be appreciated that other two-part fasteners 172 and 174 as known in the art are fully contemplated herein.

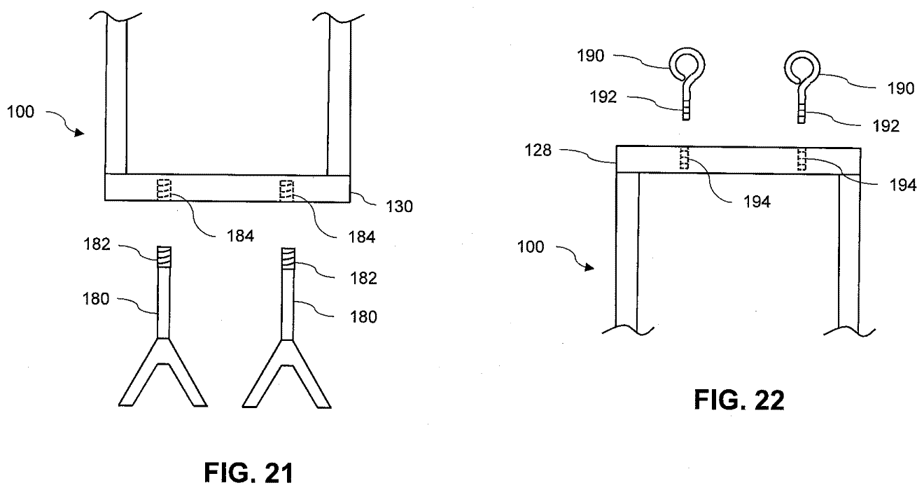

Referring now to FIG. 21, an alternative embodiment of the bottom portion of acoustic panel 100 is illustrated, with support struts 180 insertable into mounting holes 184 on bottom panel 130. In an exemplary version of this embodiment, mounting holes 184 are threaded, and support struts 180 have a threaded portion 182 allowing support struts 180 to be screwed into mounting holes 184 for attachment to bottom panel 130 of acoustic panel 100.

Support struts 180 allow flexibility in the placement of acoustic panel 100, allowing it to be both placed and moved around a room as desired, rather than simply mounted to a wall.

Referring now to FIG. 22, an alternative embodiment of the top portion of acoustic panel 100 is illustrated, with eyelets 190 insertable into mounting holes 194 on top panel 128. Mounting holes 194 are threaded, and eyelets 190 have a threaded portion 192 allowing eyelets 190 to be screwed into mounting holes 194 for attachment to top panel 128 of acoustic panel 100. Thus, acoustic panel 100 can be hung from hooks on a ceiling or elsewhere for flexibility in placement.

It will be apparent to one of ordinary skill in the art that the portions of acoustic panel 100 shown in FIGS. 21 and 22 are not mutually exclusive, and can be combined. Moreover, the variant top portions, bottom portions, or both, can be used on the various embodiments of acoustic panel described herein. Such embodiments, and the cooperative attachment of multiple panels to form an enlarged acoustic panel assembly are fully contemplated.

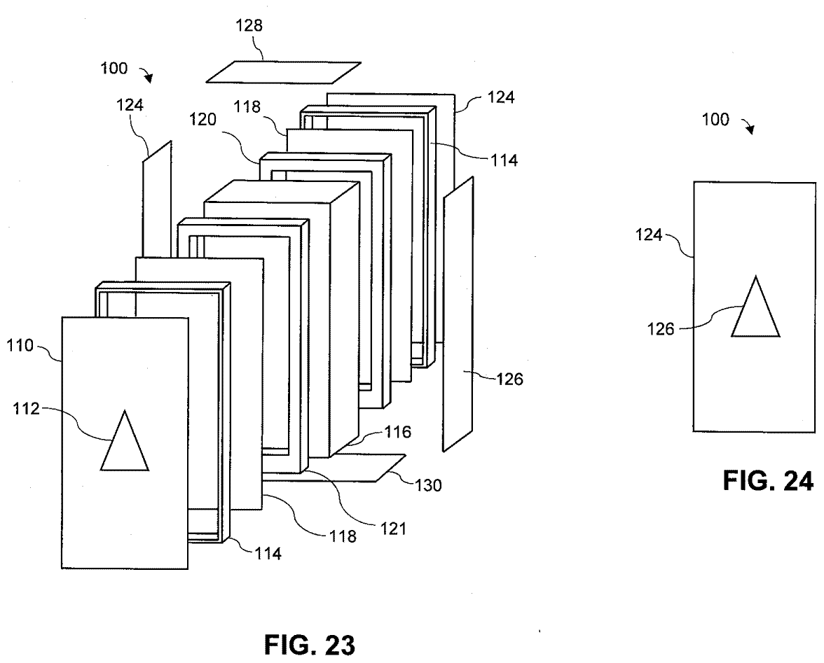

Referring now to FIG. 23, an alternative embodiment of acoustic panel 100 is shown. In this alternative embodiment, acoustic panel 100 has an additional front frame 114 for rear cover 124 to be removably mounted onto. This alternative embodiment is useful in scenarios where acoustic panel 100 is left free standing, mounted onto support struts (as shown in FIG. 21) or hung from a ceiling (as shown in FIG. 22). It is also fully envisioned that this alternative embodiment of acoustic panel 100 can have multiple acoustic insulators 116 and 117 as shown and described in detail for FIGS. 11 and 12.

The additional front frame 114 mounts directly onto rear frame 120 which is covered by second interior cloth 118, and in a preferred embodiment is made out of channeled aluminum, or alternatively can be a SEG frame. Shown in FIG. 24, rear cover 124 has decorative feature 126 that provides an additional artistic element to acoustic panel 100. Rear cover 126 also has edges and beading similar to edges 134 and beading 136 of front 110 to ensure that rear cover 126 can be easily installed and replaced as needed. The second interior cloth 118 acts as a barrier to prevent any direct contact with acoustic insulator 116 by a user.

While there have been shown what are presently considered to be preferred embodiments of the present invention, it will be apparent to those skilled in the art that various changes and modifications can be made herein without departing from the scope and spirit of the invention.

What is claimed is:

1. An acoustic panel, comprising:
a body having a top panel, a bottom panel, a left panel, a right panel, a front frame, and a rear frame;
an acoustic insulator located in the body behind the front frame;
an interior cloth positioned between the front frame and the acoustic insulator such that direct contact with the acoustic insulator is prevented;
a rear cloth attached to a back side of the rear frame; and
a front cover removably mounted to the front frame.

2. The acoustic panel of claim 1, wherein the front frame is formed out of channeled aluminum and the front cover is a silicone edge graphics (SEG) print.

3. The acoustic panel of claim 1, wherein the front frame is a SEG frame.

4. The acoustic panel of claim 3, wherein the front frame is made from either plastic or aluminum.

5. The acoustic panel of claim 1, further comprising a second front frame located between the front frame and the interior cloth.

6. The acoustic panel of claim 1, further comprising support struts removably attached to the bottom panel.

7. The acoustic panel of claim 1, further comprising eyelets removably attached to the top panel.

8. The acoustic panel of claim 1, wherein the acoustic insulator comprises rigid fiberglass.

9. The acoustic panel of claim 1, wherein the acoustic insulator comprises mineral wool insulation.

10. The acoustic panel of claim 1, wherein the acoustic insulator comprises recycled textiles.

11. An acoustic panel, comprising:
a body having a top panel, a bottom panel, a left panel, a right panel, a front frame, and a rear frame;
two acoustic insulators, comprising a first acoustic insulator and a second acoustic insulator, the two acoustic insulators located in the body behind the front frame;
an interior cloth positioned between the front frame and the two acoustic insulators such that direct contact with the two acoustic insulators is prevented;
a rear cloth attached to a back side of the rear frame; and
a front cover removably mounted to the front frame.

12. The acoustic panel of claim 11, wherein the front frame is formed out of channeled aluminum frame and the front cover is a silicone edge graphics (SEG) print.

13. The acoustic panel of claim 11, wherein the front frame is an SEG frame.

14. The acoustic panel of claim 13, wherein the front frame is made from plastic or from aluminum.

15. The acoustic panel of claim 11, further comprising a second front frame located between the front frame and the interior cloth.

16. The acoustic panel of claim 11, further comprising support struts removably attached to the bottom panel.

17. The acoustic panel of claim 11, further comprising eyelets removably attached to the top panel.

18. The acoustic panel of claim 11, wherein the first acoustic insulator comprises a velocity-based sound absorber.

19. The acoustic panel of claim 18, wherein the second acoustic insulator comprises a pressure-bases sound absorber.

20. The acoustic panel of claim 18, wherein the first acoustic insulator is made of fiberglass or mineral wool, and the second acoustic insulator is made of plywood or foam board.
